(19) United States
(12) Patent Application Publication
(10) Pub. No.: US 2006/0049000 A1
(43) Pub. Date: Mar. 9, 2006

(54) PULSED LUBRICATOR WITH COOLANT CHAMBER

(75) Inventors: Wallace G. Boelkins, Grand Rapids, MI (US); Jeffrey Coffey, Alto, MI (US); Jon Stover, Jenison, MI (US)

Correspondence Address: MCGARRY BAIR PC, 171 MONROE AVENUE, N.W., SUITE 600, GRAND RAPIDS, MI, 49503, US

(73) Assignee: UNIST, INC., Grand Rapids, MI (US)

(21) Appl. No.: 11/162,344

(22) Filed: Sep. 7, 2005

Related U.S. Application Data
(60) Provisional application No. 60/522,252, filed on Sep. 7, 2004.

(51) Int. Cl. F16N 27/00

(52) U.S. Cl. 184/7.4

(57) ABSTRACT

A pulsed metered coolant system having a variable volume coolant reservoir.

### CROSS-REFERENCE TO RELATED APPLICATION

This application claims the benefit of U.S. provisional application Ser. No. 60/522,252, filed Sep. 7, 2004, which is incorporated herein in its entirety.

### FIELD OF THE INVENTION

The invention relates generally to an apparatus for measuring and discharging predetermined quantities of fluid such as lubricants or coolants from a reservoir. In particular, the invention relates to a fluid reservoir suitable for volatile coolants.

### DESCRIPTION OF THE RELATED ART

In industrial operations, particularly in cutting and machining operations, it is highly desirable to apply liquid lubricants or coolants to the cutting tools or workpieces during the duty cycles. Such lubricants and coolants can be applied as a generally continuous stream, a succession of droplets, or in mist or “atomized” form comprising droplets of lubricant/coolant entrained in an air stream.

During the machining or cutting of a workpiece by a tool, friction between the tool and the workpiece creates heat. Cooling is achieved by applying the lubricant or coolant to the tool/workpiece interface, resulting in a heat reduction in the tool/workpiece by transferring the heat to the resulting chips and/or by the evaporation of the lubricant or coolant.

Most cooling operations can be accomplished with standard petroleum or vegetable based oils. These coolants are non-volatile at room temperature, making them easy to handle. There are cooling situations where the rate of generated heat requires a much faster rate of cooling than what is obtainable from these non-volatile coolants. Under such circumstance it is desirable to use a fluid having a very low vapor pressure such that the fluid evaporates almost immediately upon contact. These types of fluid are know as volatile fluids and are highly effective in rapidly cooling an object. Examples of such comprise traditional refrigerants that change state from liquid to gas when exposed to standard atmospheric temperatures and pressures.

Volatile fluids are relatively difficult to handle. Exposure to standard room conditions will permit the volatile fluids to immediately evaporate, destroying their utility as a coolant. When used as a coolant for a machining operation, care must be taken to make sure that the volatile fluids are handled in such a way that their corresponding cooling characteristics are not lost prior to the application of the coolant to the tool or workpiece.

### SUMMARY OF THE INVENTION

A portable metered coolant system comprises a coolant dispenser having an inlet for receiving coolant and an outlet for dispensing metered doses of the coolant, and a variable volume coolant reservoir carried by the coolant dispenser to form an integrated unit with the coolant dispenser, the variable volume coolant reservoir having a reservoir outlet fluidly coupled to the inlet of the coolant dispenser to supply the coolant from the variable volume coolant reservoir to the coolant dispenser for dispensing, wherein the volume of the variable volume coolant reservoir decreases as the coolant is dispensed.

A pulsed metered coolant system comprises a variable volume coolant reservoir having a reservoir outlet for dispensing coolant, a coolant dispenser having an inlet for receiving coolant and an outlet for dispensing metered doses of the coolant, the coolant dispenser comprising, a manifold having the inlet for fluidly coupling the variable volume coolant reservoir to the manifold, an injector fluidly coupled to the manifold for dispensing metered doses of coolant from the variable volume coolant reservoir through the outlet, and a pulsator fluidly coupled to the injector for controlling the dispensing of metered doses of coolant by the injector, whereby the variable volume coolant reservoir is carried by the coolant dispenser to form an integrated unit with the coolant dispenser, wherein the volume of the variable volume coolant reservoir decreases as the coolant is dispensed.

### BRIEF DESCRIPTION OF THE DRAWINGS

In the drawings:

FIG. 1 is a schematic representation of a first embodiment of a pulsed cooling assembly comprising a pulsatory control apparatus, an injector module, and a coolant reservoir according to the invention.

FIG. 1A is an end-on view of the pulsed cooling assembly illustrated in FIG. 1.

FIG. 2 is a sectional view of a reservoir comprising a portion of the coolant assembly illustrated in FIG. 1 taken along a longitudinal plane of the reservoir and excluding a release valve for clarity.

FIG. 3 is an enlarged sectional view of the release valve excluded from FIG. 2.

FIG. 4 is a side elevation view of the coolant assembly illustrated in FIG. 1 with a portion of the reservoir removed to show the interior workings.

FIG. 5 is a perspective view of a second embodiment of a pulsed cooling assembly comprising a pulsatory control apparatus, an injector module, and a coolant reservoir.

FIG. 6 is a first exploded view of the pulsed cooling assembly illustrated in FIG. 5 illustrating a connector for the coolant reservoir.

FIG. 7 is a second exploded view of the pulsed cooling assembly illustrated in FIG. 5 illustrating a connector for the injector module that couples with the connector for the coolant reservoir.

### DETAILED DESCRIPTION

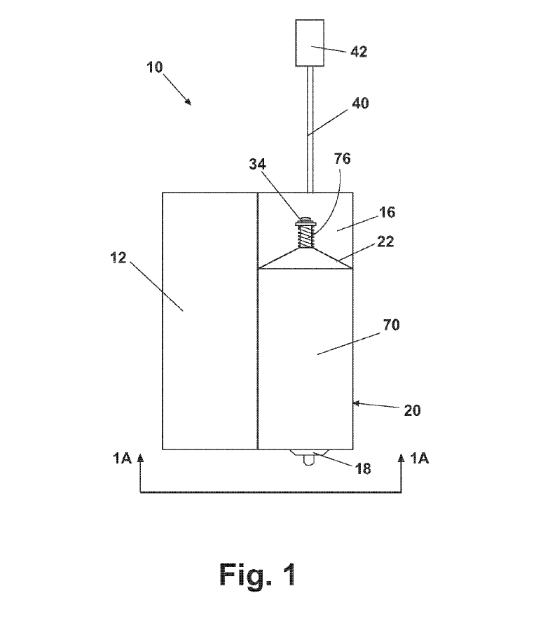

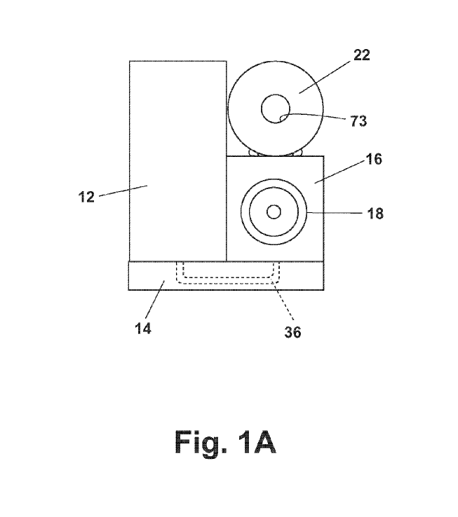

Referring now to the figures, and in particular to FIGS. 1 and 1A, a first embodiment according to the invention comprising a coolant dispenser for dispensing coolant from a coolant reservoir. The coolant dispenser is schematically illustrated in the form of a pulsed coolant assembly 10 comprising a pulsatory control apparatus 12, a fluid manifold 14, an injector module 16 comprising an injector 18, and a coolant assembly 20. The pulsatory control apparatus 12, the fluid manifold 14, the injector module 16, and the coolant assembly 20 are integrally interconnected to deliver a controlled volume of coolant at preselected intervals through a conduit 40 to an operating device 42, such as a workpiece or tool. The general structure and operation of the pulsatory control apparatus 12, the manifold 14, and the injector module 16 for use in the delivery of lubricants and coolants are well-known in the art and are more fully described in U.S. Pat. No. 5,542,498 to Boelkins, which is incorporated by reference as though set forth fully herein. As these elements and their operation are well understood by those skilled in the art, these elements will only be generally described except as necessary to a complete understanding of the invention.

The pulsatory control apparatus 12 can comprise a pneumatic pulse generator or an electric timer and solenoid valve whose basic function is to provide a sequence of recurring actuation pulses to the injector 18, in response to which the injector 18 provides a corresponding sequence of metered charges of coolant from the coolant assembly 20. The actuating pulses are normally in the form of compressed air that is supplied to the injector 18.

The injector 18 is adapted to eject discrete metered volumes of fluid from a continuous supply in response to the pulses of compressed air. Devices of this type are commonly referred to as a “metering pump” or an “injector pump.” The injector 18 comprises an in-line metering pin which moves through a closely-fitted chamber to eject a measured volume of fluid therefrom in response to the pulses of compressed air.

The fluid manifold 14 includes a plurality of apertures and associated passageways for transfer of fluids between the various component parts of the pulsed lubricator assembly 10. In particular, the fluid manifold 14 comprises one or more passageways (not shown) for fluidly connecting the pulsatory control apparatus 12 with the injector module 16 and the injector 18, such as the exemplary passageway 36 illustrated in FIG. 1A. The injector module 16 can also comprise one or more passageways (not shown) for fluidly interconnecting the fluid manifold 14, the injector 18, and the operating device 42.

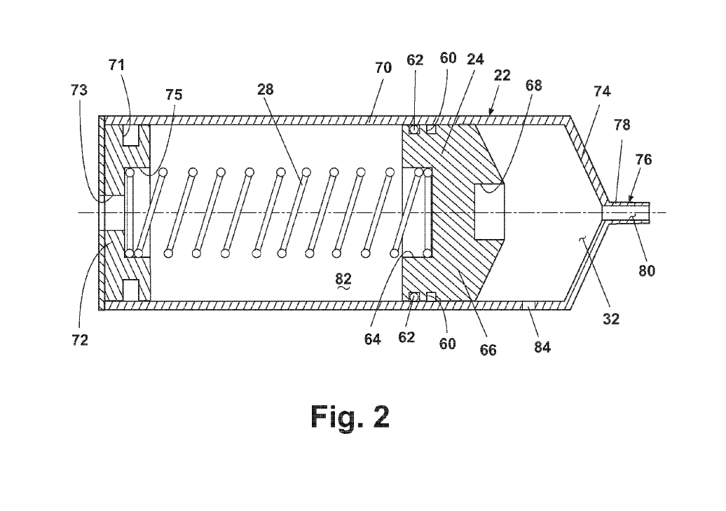

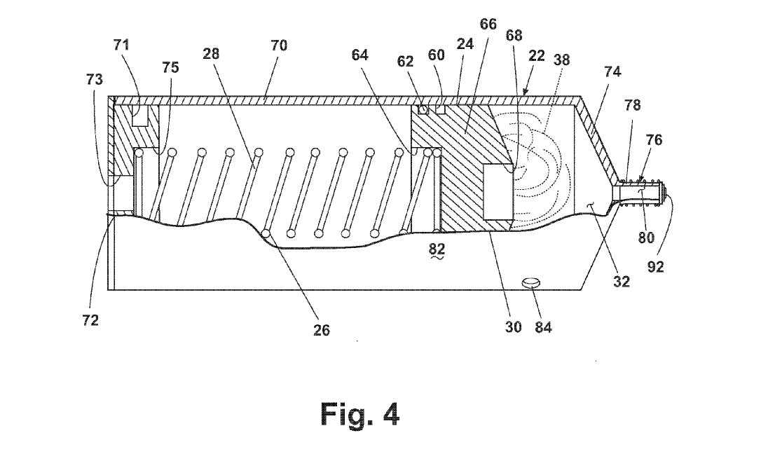

The coolant assembly 20 comprises a reservoir 22, illustrated in FIGS. 2 and 4 as an elongated, hollow cylindrical body comprising an annular reservoir wall 70 closable at a first end with an end cap 72. The reservoir is mounted in a suitable manner, such as bonding, to the injector module 16. The end cap 72 is a circular, somewhat platen-like body having a circumscribing channel 71. The end cap 72 is preferably removable, such as by securing the end cap 72 to the reservoir wall 70 by a locking pin (not shown) in the channel 71, or by threading the end cap 72 into the reservoir wall 70, or by attaching the end cap 72 to the reservoir wall 70 through threaded fasteners. The end cap 72 can be bonded to the wall 70. The end cap 72 is preferably joined to the reservoir wall 70 to provide a fluid-tight fit.

The end cap 72 is provided with a circular aperture 73 extending coaxially therethrough to enable access to the interior of the reservoir 22. The aperture 73 transitions radially to a circular spring seat 75 coaxial with the opening 73 for seating of a spring therein, as hereinafter described.

At a second end of the reservoir wall 70, a conical wall 74 extends from the reservoir wall 70 and transitions to a nipple 76 extending away from the conical wall 74 coaxially with the reservoir wall 70. The nipple 76 comprises an annular nipple wall 78 defining an orifice 80 extending coaxially therethrough. The reservoir wall 70 defines a cylindrical chamber 82, and the conical wall 74 defines a conical blow-off chamber 32. The chamber 82, the blow-off chamber 32, and the orifice 80 are fluidly interconnected. Toward the conical wall 74, a coolant outlet 84 extends radially through the reservoir wall 70 in fluid communication with the chamber 82.

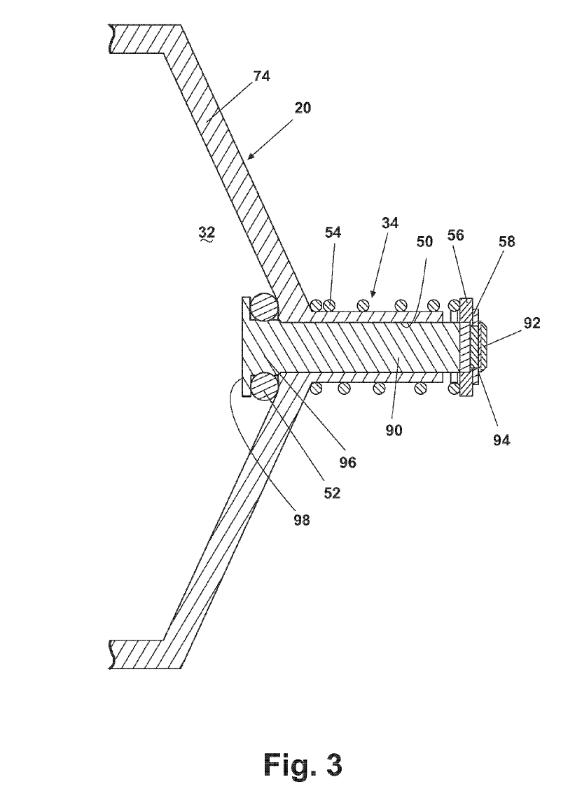

Referring now to FIG. 3, a release valve 34 is mounted in the nipple 76 for bleeding air from the blow-off chamber 32. The air release valve 34 comprises a valve pin 50 terminating at a first end in a flange 98 and adapted for slidable receipt in the orifice 80. As illustrated in FIG. 3, the valve pin 50 is an elongated, generally cylindrical member having a main shaft 90, and terminating at a proximal end in a retaining flange 98 and at a distal end in a push flange 92. The push flange 92 is separated from the main shaft 90 and defined by a circumferential groove 94. The main shaft 90 expansively transitions at the proximal end to an O-ring shaft 96 which, in turn, transitions to the retaining flange 98.

The air release valve 34 is assembled by installing an O-ring 52 onto the O-ring shaft 96 against the retaining flange 98, and inserting the main shaft 90 through the orifice 80 with the retaining flange 98 and the O-ring 52 within the blow-off chamber 32. A helical spring 54 is inserted over the nipple 76, and a washer 56 is inserted over the main shaft 90. The washer 56 is secured in-place by a well-known retaining ring 58, such as a “C-type” retaining ring, circumscribing the groove 94. The spring 54 is adapted to bear against the washer 56 and the conical wall 74 to urge the pin 50 away from the blow-off chamber 32. In a normally closed position, the air release valve 34 will be positioned with the O-ring 52 held against the conical wall 74 by the retaining flange 98 to maintain an air-tight seal. However, if sufficient force is applied to the push flange 92 to overcome the force of the spring 54 and thereby move the O-ring 52 away from the conical wall 74, fluid will escape through the orifice 80 between the main shaft 90 and the nipple wall 78. Release of the air release valve 34 will return the O-ring 52 against the conical wall 74, thereby preventing further migration of fluid through the valve 34.

As illustrated in FIGS. 2 and 4, a piston 24 is slidably received in the chamber 82 to divide the chamber 82 into a spring chamber 26 and a coolant chamber 30. The piston 24 is a generally cylindrical body adapted for slidable translation within the chamber 82. The piston 24 is provided with a circular spring seat 64 extending coaxially therein from a proximal end of the piston 24 in communication with the spring chamber 26, and in coaxial alignment with the spring seat 75 of the end cap 72. A pair of O-ring channels 60 for seating a pair of O-rings 62 therein circumscribe the piston 24. The O-rings 62 provide a fluid-tight seal of the piston 24 against the reservoir wall 70.

A distal end of the piston 24 terminates in a conical face 66 adapted for registry with the conical wall 74. A circular cavity 68 extends coaxially into the piston 24 from the conical face 66. A coil spring 28 is received in the spring chamber 26, is seated in the spring seat 64 to bear against the end cap 72, and is seated in the spring seat 75 to bear against the end cap 72 to urge the piston 24 away from the end cap 72. As the volatile coolant is evacuated from the coolant chamber 30, the piston 24 will be urged toward the blow-off chamber 32.

In this manner, the effective volume of the coolant chamber is reduced as the volatile coolant is used. The variable volume of the coolant chamber 30 makes the coolant assembly 20 highly suitable for storing volatile coolants and preventing their expansion as the volatile coolant is used. In addition to the variable volume, the spring force applied by the coil spring 28 also aids in keeping the volatile coolant from expanding and changing state from a liquid to a gas in the coolant chamber by applying a pressure on the volatile coolant. The force of the spring should be great enough such that the pressure applied by the piston on the volatile coolant is greater than the vapor pressure of the volatile coolant. The pressurization of the volatile coolant also makes it easier for the volatile coolant to be expelled from the coolant chamber 30 and into the manifold 14 in response to a demand for volatile coolant by the injector module.

Referring again to FIG. 1A, the reservoir 22 is fluidly interconnected with the fluid manifold 14, which is fluidly interconnected with the injector module 16, so that the aperture 84 is in fluid communication with a coolant aperture 36 extending through the fluid manifold 14. The coolant aperture 36 is fluidly and operably connected with the injector 18, which is fluidly connected through a coolant line 40 to the operating device 42, such as a workpiece, cutting tool, bearing assembly, and the like.

In operation, the pulsatory control 12 will send one or more pulses of pressurized air to the injector module when the coolant 38 is required. The pulses of pressurized air trigger the injector 18 to draw in and expel a charge of coolant from the coolant reservoir 30 through the line 40 and to the workpiece 42. As each charge of volatile coolant is removed, the force applied by the coil spring 28, combined with the vacuum generated by the action of the injector 18 advances the piston within the reservoir 20 toward the release valve 34 until all of the volatile coolant is ultimately evacuated. The advancing of the piston reduces the effective volume of the coolant chamber which eliminates any extra volume that the volatile coolant could expand into, which might result in the volatile coolant undesirably changing phase, from a liquid to a gas, for example, and losing its cooling properties. The coil spring also maintains the volatile coolant under pressure which further limits its ability to change phase.

It is not uncommon for the volatile coolant to have some impurities, which can separate from the volatile coolant over time. These impurities can separate in the form of a liquid or gas, which collects on top of the volatile coolant 38. The release valve permits these impurities to be evacuated from the reservoir.

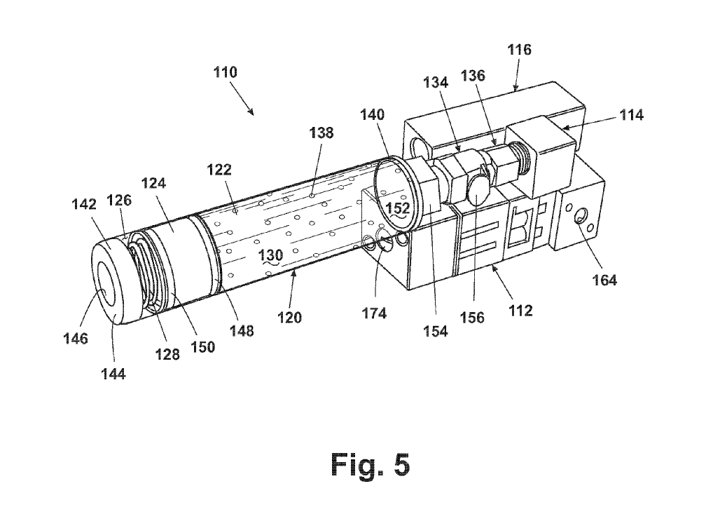

FIGS. 5-7 illustrate a second embodiment of the pulsed lubricator assembly 110 comprising a coolant dispenser for dispensing coolant from a coolant reservoir. The coolant dispenser is illustrated in the form of a pulsatory control apparatus 112, a fluid manifold 114, an injector module 116, and a coolant assembly 120. The coolant assembly 120 comprises a generally hollow, cylindrical reservoir 122 having a closed distal end 140 and an open proximal end 142. A movable piston 124 is slidably enclosed within the reservoir 122 and divides the reservoir 122 into a spring chamber 126 on a proximal side of the piston 124 and a coolant chamber 130 on a distal side of the piston 124. A helical spring 128 is attached to the piston 124 and enclosed within the spring chamber 126. The reservoir 122 can be fabricated of a suitable material which is unreactive with the fluid to be retained therein, such as stainless steel, nylon, or other polymeric materials having suitable strength and durability for the purposes described herein. Preferably, the reservoir 122 is transparent to provide the user with a visual indication of the volume of fluid in the coolant chamber 130.

The open proximal end 142 is provided with an annular stop 144 having an aperture 146 extending coaxially therethrough. The annular stop 144 is fabricated of a suitable material, such as aluminum, having a diameter adapted for a frictional fit within the reservoir 122. The frictional fit can be facilitated by providing an interference fit with an annular barb circumscribing the annular stop 144 to engage the inside of the reservoir 122. The spring 128 has a diameter somewhat greater than the aperture 146 to enable the spring 128 to bear against the annular stop 144.

The piston 124 is provided with a seal O-ring 148 circumscribing a distal end of the piston 124 and preferably seated in a circumscribing groove in the piston 124 to enable the piston to translate through the reservoir 122 while preventing fluid from escaping between the piston 124 and the reservoir 122. A wipe O-ring 150 circumscribes a proximal end of the piston 124 and is preferably seated in a circumscribing groove in the piston 124 to remove machining chips, dust, and other impurities that may enter the spring chamber 126 through the aperture 146 during use of the pulsed lubricator assembly 110.

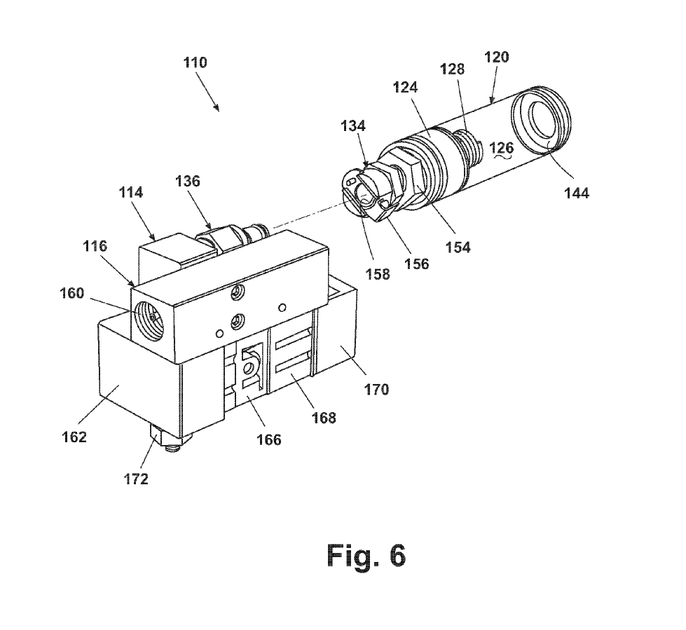

The closed distal end 140 of the reservoir 122 is provided with a somewhat convex or conical shape, terminating in an end wall 154, which, as illustrated in FIG. 5, can comprise a hexagonal fitting, similar to a nut, suitable for grasping with a wrench or similar tool. The end wall 154 is provided with a threaded aperture (not shown) therethrough for installation of an air release valve 134 therein. A suitable air release valve is a Keyed Series Non-Spill Quick-Release Coupling manufactured by Colder Products Company of St. Paul, Minnesota. The air release valve 134, illustrated in FIG. 6, is provided with a release trigger 156 and a valve orifice 158. The valve orifice 158 is provided with a spring-biased valve (not shown) which is normally biased to a closed position but which can be opened by axially depressing the valve face through the orifice 158. The end wall 154 and air release valve 134 define a fluid conduit extending from the coolant chamber 130 to the valve orifice 158.

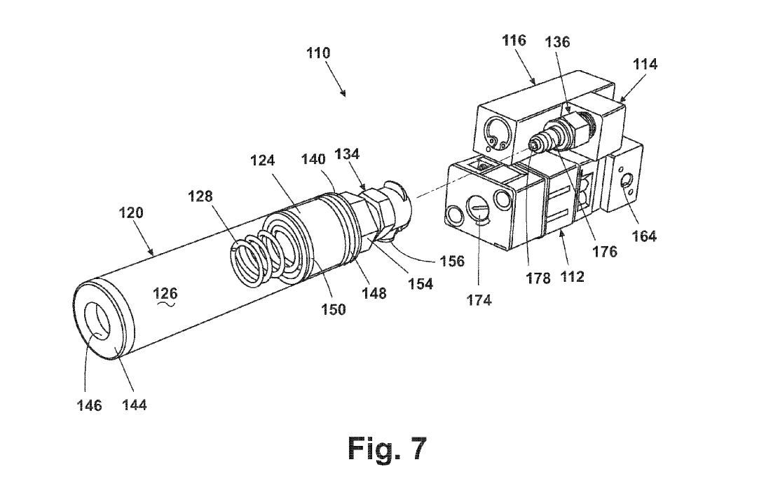

Referring to FIG. 7, an inlet coupling 136 adapted for mating registry with the air release valve 134 is threadably attached to the fluid manifold 114. The inlet coupling 136 is a generally tubular member having an insert tube 176 adapted for slidable insertion in the valve orifice 158, terminating in a sealing duct 178 biased outwardly from the insert tube 176 and adapted for fluid cooperation with the spring-biased valve in the valve orifice 158. The insert tube 176 and the air release valve 134 are adapted so that the insert tube 176 is locked into engagement with the air release valve 134 by a well-known locking mechanism, which can be released by actuating the release trigger 156 in order to separate the air release valve 134 from the insert tube 176. When the insert tube 176 is seated in the air release valve 134, the sealing duct 178 is biased into cooperative engagement with the spring-biased valve in the valve orifice 158 in order to maintain a fluid-tight coupling between the air release valve 134 and the insert tube 176.

The inlet coupling 136 and air release valve form a quick-release valve to enable the coolant reservoir 120 to be quickly and easily coupled/uncoupled to the fluid manifold 114. It is contemplated that a source of pressurized coolant will also have a suitable quick-release connector thereby enabling the quick filling of the coolant reservoir 120 by uncoupling the coolant reservoir 120 from the manifold 114 and coupling it to the source of pressurized where the reservoir 120 will be immediately filled. The reservoir can then be coupled to the manifold. This configuration makes the pulsed lubricator of the invention ideally suitable for portable use where the coolant reservoir is not continuously supplied coolant.

The pulsatory control apparatus 112 is a generally well-known device comprising an air inlet module 162 which is adapted for fluid connection in a generally well-known manner to a source of compressed air (not shown) for operating the pulsatory control apparatus 112. The air inlet module 162 is provided with an air adjustment valve 172 for adjusting the flow of air to the pulsatory control apparatus 112. The air inlet module 162 is fluidly coupled to a valve module 166, which, in turn is fluidly coupled to an air chamber 168. Air is delivered from the air inlet module 162 through the valve module 166 to the air chamber 168 for controlled delivery to the injector module 116. The injector module 116 is fluidly connected through the fluid manifold 114 to the coolant assembly 120.

A fluid adjustment module 170 is coupled to the air chamber 168 to control the volume and pressure of air in the inner chamber 168. The fluid adjustment module 170 is provided with a fluid adjustment valve 174 for adjusting the frequency of the air pulses delivered by the pulsatory control apparatus 112 to the injector module 116. Air pulses delivered by the pulsatory control apparatus 112 to the injector module 116 control the delivery of coolant from the reservoir 122 through the fluid manifold 114 for delivery through an output orifice 160 in the injector module 116.

In operation, the coolant chamber 130 is filled with coolant under pressure by suitably coupling the air release valve 134 with a supply of coolant as previously described. When the spring-biased valve in the valve orifice 158 is opened, coolant will flow under pressure into the coolant chamber 130, urging the piston 124 toward the proximal end 142. The spring 128 will dampen any impact of the piston 124 against the annular stop 144 during the filling process, and will remain compressed between the annular stop 144 and the piston 124 for a period of time during delivery of coolant from the coolant assembly 120. Initially, if any air is present in the coolant chamber 130, the coolant assembly 120 can be oriented with the air release valve 134 in an upper position so that the spring-biased valve in the valve orifice 158 can be opened briefly to enable blow-off of the entrapped air. The convex or conical shape of the end wall 154 will facilitate the blow-off of this entrapped air.

The coolant assembly 120 is then attached to the fluid manifold 114 by coupling the inlet coupling 136 to the air release valve 134. Coolant can then flow from the coolant chamber 130 through the manifold 114 into the injector module 116 for delivery through the output orifice 160. The pulsatory control apparatus 112 will deliver regularly-spaced air pulses to the injector module 116 so that the injector module 116 will deliver regularly-spaced doses of coolant through the output orifice 160. The action of the pulsatory control apparatus 112 imposes a vacuum at the spring-biased valve in the valve orifice 158 which facilitates the flow of coolant through the fluid manifold 114 into the injector module 116.

The pulsed lubricator assembly is a portable coolant device which can be readily attached to both hand and bench tools for cooling workpieces during cutting, milling, and forming operations. The portability enables the pulsed lubricator assembly to be located in the optimal position for cooling a workpiece, and to be readily installed among a variety of workpieces as needed. The use of a quick connect valve assembly for the coolant reservoir facilitates the use of small volume reservoirs which can be readily removed and refilled, thus enhancing the portability of the device. The use of pneumatics to control the pulsed lubricator assembly eliminates safety issues relating to electrically controlled devices, particularly with the use of potentially flammable coolants.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

What is claimed is:

1. A portable metered coolant system, comprising:
a coolant dispenser having an inlet for receiving coolant and an outlet for dispensing metered doses of the coolant; and
a variable volume coolant reservoir carried by the coolant dispenser to form an integrated unit with the coolant dispenser, the variable volume coolant reservoir having a reservoir outlet fluidly coupled to the inlet of the coolant dispenser to supply the coolant from the variable volume coolant reservoir to the coolant dispenser for dispensing; wherein the volume of the variable volume coolant reservoir decreases as the coolant is dispensed.

2. A portable metered coolant system according to claim 1, wherein the variable volume coolant reservoir is configured to automatically decrease in volume as the coolant is dispensed.

3. A portable metered coolant system according to claim 1, wherein the variable volume coolant reservoir is configured to decrease in volume an amount commensurate with the volume of dispensed coolant.

4. A portable metered coolant system according to claim 1, wherein the coolant dispenser generates a vacuum that is applied to the variable volume coolant reservoir to effect the dispensing of the coolant by drawing the coolant from the reservoir.

5. A portable metered coolant system according to claim 1, wherein the variable volume coolant reservoir comprises a valve defining the reservoir outlet and coupled to the dispenser inlet.

6. A portable metered coolant system according to claim 5, wherein the valve is open when the variable volume coolant reservoir is coupled to the coolant dispenser and closed when the variable volume coolant reservoir is decoupled from the coolant dispenser.

7. A portable metered coolant system according to claim 6, wherein the valve is releasably coupled to the inlet.

8. A portable metered coolant system according to claim 7, wherein the inlet comprises a valve insert for releasably coupling the valve to the inlet.

9. A portable metered coolant system according to claim 1, wherein the variable volume coolant reservoir comprises a moveable piston mounted therein and the movement of the piston varies the volume of the coolant chamber.

10. A portable metered coolant system according to claim 9, wherein the variable volume coolant reservoir is open at a first end and closed at a second end and the piston is located between the first and second ends and defines a coolant chamber with the second end.

11. A portable metered coolant system according to claim 10, wherein a valve defining the reservoir outlet is mounted in the second end and fluidly coupled to the coolant chamber.

12. A portable metered coolant system according to claim 11, wherein the valve can be opened to release fluid from the coolant chamber.

13. A portable metered coolant system according to claim 1, wherein the coolant dispenser comprises an injector fluidly coupled to the variable volume coolant reservoir for dispensing metered doses of coolant from the variable volume coolant reservoir.

14. A portable metered coolant system according to claim 13, wherein the coolant dispenser comprises a manifold fluidly coupling the variable volume coolant reservoir to the injector.

15. A portable metered coolant system according to claim 14, wherein the coolant dispenser further comprises a pulsator fluidly coupled to the injector for controlling the dispensing of metered doses of coolant by the injector.

16. A portable metered coolant system according to claim 15, wherein the pulsator is pneumatically actuated.

17. A portable metered coolant system according to claim 1, wherein dispensing of the coolant from the variable volume coolant reservoir is achieved by at least one of pressurizing the coolant in the variable volume coolant reservoir, or applying a vacuum to the coolant at the reservoir outlet.

18. A pulsed metered coolant system, comprising:
a variable volume coolant reservoir having a reservoir outlet for dispensing coolant;
a coolant dispenser having an inlet for receiving coolant and an outlet for dispensing metered doses of the coolant, the coolant dispenser comprising:
a manifold having the inlet for fluidly coupling the variable volume coolant reservoir to the manifold;
an injector fluidly coupled to the manifold for dispensing metered doses of coolant from the variable volume coolant reservoir through the outlet; and
a pulsator fluidly coupled to the injector for controlling the dispensing of metered doses of coolant by the injector;
wherein the volume of the variable volume coolant reservoir decreases as the coolant is dispensed.

19. A pulsed metered coolant system according to claim 18, wherein the variable volume coolant reservoir is configured to automatically decrease in volume as the coolant is dispensed.

20. A pulsed metered coolant system according to claim 19, wherein the variable volume coolant reservoir comprises a valve defining the reservoir outlet and coupled to the inlet.

21. A pulsed metered coolant system according to claim 20, wherein the valve is open when the variable volume coolant reservoir is coupled to the manifold, and closed when the variable volume coolant reservoir is decoupled from the manifold.

22. A pulsed metered coolant system according to claim 20, wherein the valve is releasably coupled to the inlet.

23. A pulsed metered coolant system according to claim 22, wherein the inlet comprises a valve insert for releasably coupling the valve to the inlet.

24. A pulsed metered coolant system according to claim 18, wherein the variable volume coolant reservoir comprises a moveable piston mounted therein and the movement of the piston varies the volume of the coolant chamber.

25. A pulsed metered coolant system according to claim 24, wherein the variable volume coolant reservoir is open at a first end and closed at a second end and the piston is located between the two ends and defines a coolant chamber with the second end.

26. A pulsed metered coolant system according to claim 25, wherein a valve defining the reservoir outlet is mounted in the second end and fluidly coupled to the coolant chamber.

27. A pulsed metered coolant system according to claim 18, wherein the pulsator is pneumatically actuated.

28. A pulsed metered coolant system according to claim 18, wherein dispensing of the coolant from the variable volume coolant reservoir is achieved by at least one of pressurizing the coolant in the variable volume coolant reservoir, or applying a vacuum to the coolant at the reservoir outlet.

29. A pulsed metered coolant system according to claim 18, wherein the variable volume coolant reservoir is carried by the coolant dispenser to form an integrated unit with the coolant dispenser.
